(19) United States
(12) Patent Application Publication
(10) Pub. No.: US 2014/0227626 A1
(43) Pub. Date: Aug. 14, 2014

(54) PROTON CONDUCTING ELECTROCHEMICAL CELL AND METHOD OF MAKING SUCH A CELL

(71) Applicants: AREVA, Paris (FR); ARMINES, Paris Cedex 06 (FR); CENTRE NATIONAL DE LA RECHERCHE SCIENTIFIQUE (C.N.R.S.), Paris (FR)

(72) Inventors: Béatrice Sala, Saint Gely Du Fesc (FR); Frédéric Grasset, Montpellier (FR); Elodie Tetard, Montpellier (FR); Kamal Rahmouni, Montpellier (FR); Dominique Goeuriot, Monistrol Sur Loire (FR); Baroudi Bendjeriou, Saint-Etienne (FR); Hisasi Takenouti, Ollainville (FR)

(73) Assignees: AREVA, Paris (FR); ARMINES, Paris (FR); Centre National de la Recherche Scientifique (C.N.R.S.), Paris (FR)

(21) Appl. No.: 14/350,777

(22) PCT Filed: Oct. 11, 2012
(86) PCT No.: PCT/FR2012/052305

§ 371 Date: Apr. 9, 2014

(30) Foreign Application Priority Data
Oct. 12, 2011 (FR) 1159220

(51) Int. Cl. H01M 8/12; C25B 9/10

(52) U.S. Cl. CPC H01M 8/1246; C25B 9/10
USPC 429/482; 204/252; 427/77

(57) ABSTRACT

The present invention relates to a proton-conductive electrochemical cell (10), comprising an electrolytic membrane (13) made of a ceramic and an electrode (11, 12) made of a cermet, said electrochemical cell (10) being obtained directly by a method of co-sintering a ceramic layer, capable of forming the electrolytic membrane (13), and a cermet layer, capable of forming the electrode (11, 12), in a sintering tool at a sintering temperature of the ceramic that makes it possible to render said ceramic layer, capable of forming the electrolyte (13), gas-tight, wherein said cell (10) is characterised in that said cermet consists of the mixture of a ceramic and an electronically conductive passivatable alloy including at least 40 mol % chromium capable of forming a passive layer, the nature and the chromium content of said passivatable alloy enabling said electrochemical cell to be co-sintered with a membrane densification of more than 90% without melting said alloy.

### TECHNICAL FIELD

The field of the invention is electrolysis devices such as high temperature electrolysers comprising a proton conducting membrane.

The invention relates more particularly to electrochemical cells with electron conducting electrodes (anode and cathode) bonded to a proton conducting membrane by compaction and sintering.

The invention may also relate to fuel cells, to which technological developments of high temperature electrolysers are directly applicable.

### STATE OF THE ART

Current high temperature electrolyser technologies, for example of the SOEC (Solid Oxide Electrolyser Cell) type, or fuel cells, for example of the SOFC (Solid Oxide Fuel Cell) are based on the use of two electron conducting electrodes, separated by an electrolyte with an electronically insulating ionic (proton) conducting membrane and separating gases in the anode and cathode compartments thus forming a structure called an electrochemical cell or an elementary assembly.

Normally in high temperature electrolysers with a proton conducting ceramic membrane, the cathode is formed for example by a zirconia/nickel or zirconia/cobalt type cermet.

On the other hand, it is known that metallic oxide compounds can be used, usually with a perovskite structure, for the anode that operates in oxidising environment. It is also known that noble metals such as gold, silver or even platinum can be used that resist corrosion and oxidation.

However, the use of noble metals increases the cost for manufacturing these electrodes.

In order to avoid the use of relatively expensive noble metals for making an electrode operating in an oxidising medium, patent U.S. Pat. No. 7,351,488 disclosed the use of cermets for making the anode and the cathode that resist oxidation in an oxidising atmosphere. These cermets are advantageously formed by mixing an ion conducting ceramic (identical to that used for making the electrolyte) and a transition metal such as Chromium (Cr), Iron (Fe) or Copper (Cu).

However satisfactory cohesion with the electrolyte cannot be achieved during manufacturing of an electrochemical cell using such cermets. Furthermore, manufacturing of an electrochemical cell with such cermets requires many operations and many thermal cycles.

Patent U.S. Pat. No. 6,605,316 discloses a method of manufacturing an electrochemical cell by co-sintering the electrolytic membrane and a cermet electrode in a single step at a sufficiently high temperature to enable sintering of the electrode and densification of the electrolysis, so as to improve cohesion between the electrolyte and electrodes.

However, the use of such a manufacturing method cannot guarantee a densification of more than 90% despite the claims made in the document, because the sintering temperature of the cell is limited by the melting temperature of the cermet transition metal.

### Presentation of the Invention

In this context, the invention aims at disclosing a proton conducting electrochemical cell capable of solving the problems mentioned above, the properties of which can improve densification of the electrolytic membrane.

To achieve this, the invention discloses a proton conducting electrochemical cell comprising an electrolytic membrane formed by a ceramic and an electrode formed by a cermet; said electrochemical cell being obtained directly by a method of co-sintering a ceramic layer capable of forming the electrolytic membrane and a cermet layer capable of forming the electrode, in a sintering tool at a sintering temperature of the ceramic capable of making said ceramic layer designed to form the electrolyte gas tight, said cell being characterised in that said cermet is composed of a mix of a ceramic and a passivatable electron conducting alloy comprising at least 40% by mole of Chromium capable of forming a passive layer, the nature and Chromium content of said passivatable alloy making it possible to co-sinter said electrochemical cell with densification of the membrane to more than 90% without melting of said alloy.

Passivation or passivity represents a state of metals or alloys in which their corrosion rate is significantly slowed due to the presence of a passive film or a passive layer, which corresponds to the adsorption of oxygen on the surface of the metal. Passive layers refers to thin passive layers (i.e. with a thickness of a few atom layers) often based on chromium as is the case for non-oxidisable alloys of transition metals containing chromium, CrN, CrMo, CrTa, CrTi, CrW, CrNi, CrCo.

Thus, the melting temperature of the alloy may be modified due to the nature and the metal content of passivatable alloy forming the Cermet so that it remains higher than the sintering temperature, under a non-oxidising (advantageously reducing) atmosphere of the ceramic of the electrolytic membrane (to make it gas tight).

It is thus possible to make the electrochemical cell in a single cycle sintering the different layers, at the sintering temperature of the electrolytic membrane and without any prior sintering operation of the electrodes.

This co-sintering can thus give a very good cohesion between the different layers forming the electrochemical cell, while guaranteeing a densification of the membrane of more than 90%, and preferably more than 94%.

Advantageously, the metal element in the alloy must not degrade the ion conduction of the ceramic by diffusion.

Advantageously, said passivatable alloy must remain electronically conducting and maintain good mechanical strength, depending on the atmosphere in the compartment (anode or cathode).

The proton conducting electrochemical cell according to the invention may also have one or several of the following characteristics taken individually or in any technically possible combination:
said passive protection layer is electronically conducting;
said passivatable electronic conducting alloy forming the cermet of said electrode is an alloy containing chromium and a transition metal;
the melting temperature of said alloy is higher than the sintering temperature of said electrolytic membrane under a non-oxidising atmosphere;
the ceramic forming said cermet is of the same nature as the ceramic forming said electrolytic membrane;
said ceramic forming said cermet of said electrode and said ceramic forming said electrolytic membrane are formed by a perovskite structure based on zirconate or titanate or cerate or silicate;
the sintering temperature is higher than 1500° C.

A second aspect of the invention also relates to a high temperature electrolysis device comprising a proton conducting electrochemical cell according to the invention.

A third aspect of the invention also relates to a method of manufacturing a proton conducting electrochemical cell according to the invention characterised in that the method comprises:
a placement step by superposition of
   a first cermet layer composed of the mix of a ceramic and a passivatable electron conducting alloy comprising at least 40% by mole of chromium and capable of forming a first electrode,
   a ceramic layer capable of forming said electrolyte,
   a second cermet layer formed by the mix of a ceramic and a passivatable electron conducting alloy comprising at least 40% by mole of chromium capable of forming a second electrode;
a co-sintering step of the different layers in a sintering tool at a ceramic sintering temperature capable of making said ceramic layer designed to form the electrolyte with a densification of more than 90%, gas tight.

According to one advantageous embodiment, said co-sintering step is done at a sintering temperature enabling densification of the electrolyte to more than 94%.

### DESCRIPTION OF THE FIGURES

Other characteristics and advantages of the invention will become clearer after reading the following description given for information and that is in no way limitative, with reference to the appended figures among which:

FIG. 1 shows a diagrammatic sectional view of an electrochemical cell according to the invention;

FIG. 2 shows a phase diagram of the cobalt-chromium (Co—Cr) alloy;

FIG. 3 shows a phase diagram of the chromium-nickel (Cr—Ni) alloy;

FIG. 4 shows a phase diagram of the chromium-iron (Cr—Fe) alloy;

FIG. 5 shows a block diagram of the method of manufacturing the electrochemical cell according to the invention.

### DETAILED DESCRIPTION OF AT LEAST ONE EMBODIMENT

The electrochemical cell 10, also called the elementary assembly, is shown in FIG. 1.

The electrochemical cell is formed by a proton conducting electrolytic membrane 13, along the sides of which the electrodes 11 and 12 (anode and cathode) lie.

The electrode 11, 12 in the electrochemical cell 10 according to the invention is formed by a cermet composed of a mix of a ceramic and a chromium-based metallic alloy.

The ceramic of the electrode 11, 12 is advantageously the same ceramic as that used for making the electrolytic membrane 13.

According to a first advantageous embodiment of the invention, the proton conducting ceramic used for making the cermet is a zirconate type provskite ceramic with the general formula AZrO3 that can advantageously be doped by an element A chosen among the lanthanides.

Therefore the use of this type of ceramic to make the membrane requires the use of a sintering temperature of more than 1500° C. (sintering under reducing atmosphere) in order to obtain sufficient densification to be gas tight. The sintering temperature of the membrane 13 is defined more particularly as a function of the nature of the ceramic but also as a function of the required porosity ratio. The higher the sintering temperature, the lower the porosity of the electrolytic membrane 13. Conventionally, it is considered that the porosity of the electrolytic membrane 13 must be less than 10% and preferably less than 6% (or its density must be more than 90% and preferably more than 94%), in order to be gas tight.

Advantageously, the ceramic is sintered under a reducing atmosphere to prevent oxidation of the metal at high temperature, in other words under a hydrogen (H₂) and argon (Ar) atmosphere, or even a carbon monoxide (CO) atmosphere if there is no risk of carbonation.

Due to the particularly advantageous aspect of the method of making the electrochemical cell according to the invention making it possible to perform a single sintering operation in a single tooling, the electrodes 11, 12 of the elementary assembly 10 are also sintered at a temperature of more than 1500° C. (in the example of sintering a zirconate type ceramic).

The metallic alloy of the cermet is a passivatable electron conducting alloy capable of forming a protective oxide layer so as to protect it in an oxidising environment (i.e. at the anode of an electrolyser).

The passivatable alloy comprises chromium so as to have a cermet with the special feature that it does not oxidise at high temperature. The content by mole of chromium in the alloy is determined such that the melting point of the alloy is higher than the sintering temperature of the ceramic. Remember that the sintering temperature means the sintering temperature necessary to sinter the electrolyte membrane so as to make it gas tight.

Advantageously, the chromium alloy also comprises a transition metal capable of maintaining an electron conducting nature of the passive layer. Thus, the chromium alloy is an alloy of chromium and one of the following transition metals: Cobalt, Nickel, Iron, Titanium, Niobium, Molybdenum, Tantalum, Tungstene, etc.

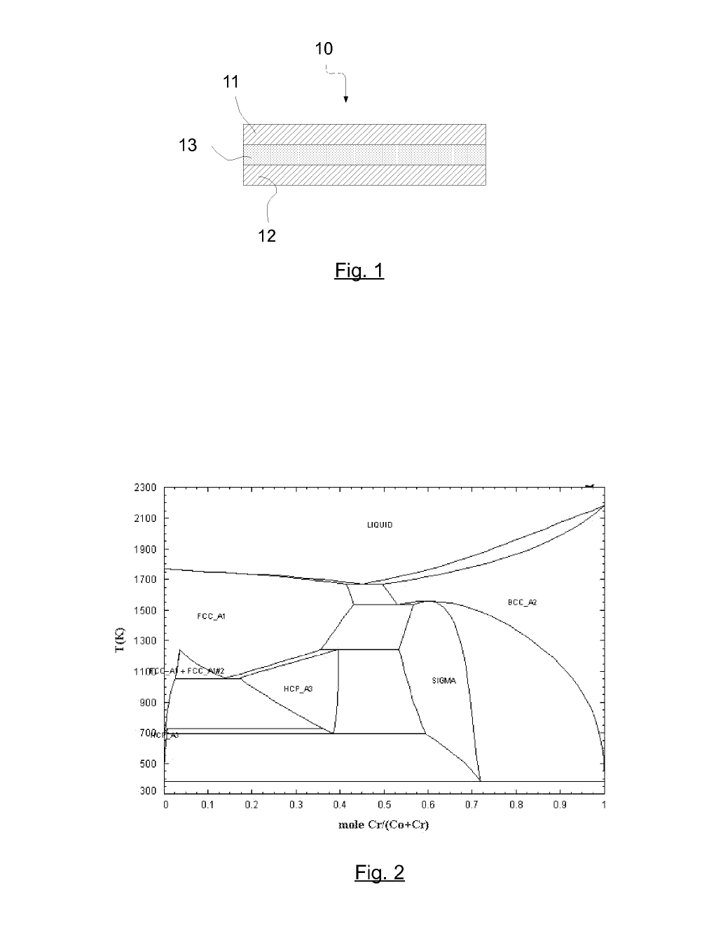

FIG. 2 shows the phase diagram of the cobalt-chromium alloy. Thus, in order to obtain a melting point of the alloy exceeding the sintering temperature of the zirconate type ceramic (i.e. 1500° C.), the chromium content must be higher than 70% (by mole) and advantageously 80% (by mole).

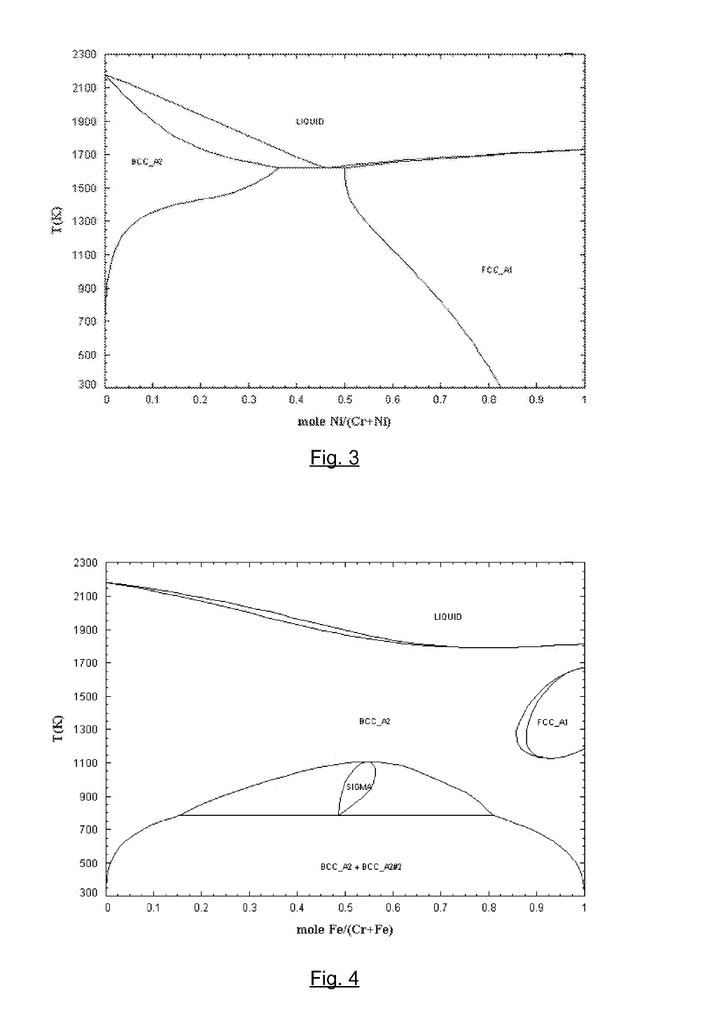

When the chromium alloy is a chromium-nickel alloy, the chromium content must be greater than 65% by mole (FIG. 3).

When the chromium alloy is a chromium-iron alloy, the chromium content must be greater than 40% by mole (FIG. 4).

Due to the advantageous composition of the electrode 11, 12, the electrochemical cell 10 can be made in a single sintering operation under a non-oxidising (preferably reducing) atmosphere because the composition of the electrode 11, 12 can resist high temperatures when sintering the membrane 13 under a reducing atmosphere.

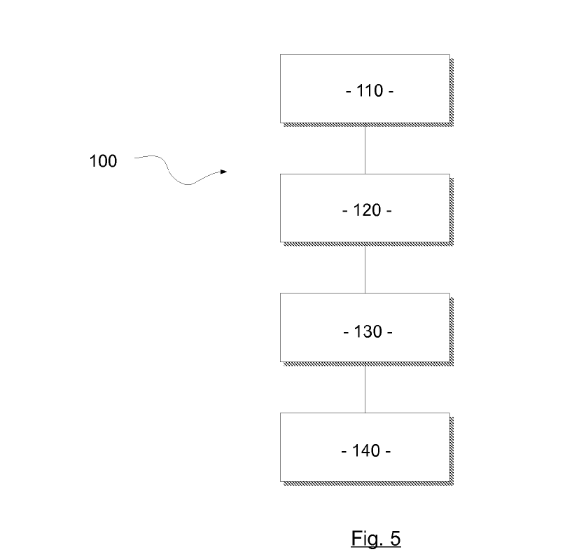

The method 100 of manufacturing the electrochemical cell is shown particularly in FIG. 5.

The first step 110 in the method of manufacturing the electrochemical cell 10 is a step in which a cermet layer, a ceramic layer and a second cermet layer are superposed in a die, for example cylindrical in shape.

The cermet and the ceramic are previously synthesised conventionally either by band casting or by powder synthesis.

It is also possible to insert intermediate layers between the cermet layers and the ceramic layer, forming the electrolytic membrane, that can act as either:
protective layers for the electrolytic membrane to prevent diffusion of species between the electrodes 11, 12 and the electrolytic membrane 13, or
accommodation layers to compensate for differences between the coefficients of thermal expansion of the cermet layers and the ceramic layer, particularly due to the presence of metal in the cermet.

The second step 120 in the manufacturing method 100 is a step to compact all the layers superposed during the previous step 110.

The third step 130 of the manufacturing method 100 is a sintering step of the assembly under a reducing atmosphere so as to densify the ceramic.

The invention has been described particularly with reference to a zirconate type ceramic. However, the invention is also applicable with a titanate, cerate or silicate type ceramic for which the sintering temperatures, particularly under a reducing atmosphere, are more than 1500° C.

The invention has been described particularly for a high temperature electolyser comprising a proton conducting membrane; however, the invention is also applicable to fuel cells, typically SOFC type cells, to which technological developments of high temperature electrolysers are directly applicable.

Naturally, the invention is not limited to the embodiments described with reference to the figures and variants could also be envisaged without going outside the scope of the invention. In particular, the proportions of the different materials are given only for illustrative purposes. Furthermore, the electrochemical cell may have geometries different from the disclosed geometry.

1. Proton conducting electrochemical cell comprising an electrolytic membrane formed by a ceramic and an electrode formed by a cermet; said electrochemical cell being obtained directly by a method of co-sintering a ceramic layer capable of forming the electrolytic membrane and a cermet layer capable of forming the electrode, in a sintering tool at a sintering temperature of the ceramic capable of making said ceramic layer designed to form the electrolyte gas tight so as, said cell being wherein said cermet is composed of a mix of a ceramic and a passivatable electron conducting alloy comprising at least 40% by mole of Chromium capable of forming a passive layer, the nature and Chromium content of said passivatable alloy making it possible to co-sinter said electrochemical cell with densification of the membrane to more than 90% without melting of said alloy.

2. Proton conducting electrochemical cell according to claim 1, wherein said protective passive layer is an electron conducting layer.

3. Proton conducting electrochemical cell according to claim 1, wherein said passivatable electron conducting alloy forming the cermet of said electrode is an alloy comprising chromium and a transition metal.

4. Proton conducting electrochemical cell according to claim 1, wherein the melting temperature of said alloy is higher than the sintering temperature of said electrolytic membrane under a non-oxidising atmosphere.

5. Proton conducting electrochemical cell according to claim 1, wherein the ceramic forming said cermet is of the same nature as the ceramic forming said electrolytic membrane.

6. Proton conducting electrochemical cell according to claim 1, wherein said ceramic forming said cermet of said electrode and said ceramic forming said electrolytic membrane are formed by a perovskite structure based on zirconate or titanate or cerate or silicate.

7. Proton conducting electrochemical cell according to claim 1, wherein the sintering temperature is higher than 1500° C.

8. High temperature electrolysis device comprising a proton conducting electrochemical cell according to claim 1.

9. A Method of manufacturing a proton conducting electrochemical cell according to claim 1 wherein the method comprises:
a placement step by superposition of:
a first cermet layer composed of the mix of a ceramic and a passivatable electron conducting alloy comprising at least 40% by mole of chromium and capable of forming a first electrode,
a ceramic layer capable of forming said electrolyte,
a second cermet layer formed by the mix of a ceramic and a passivatable electron conducting alloy comprising at least 40% by mole of chromium capable of forming a second electrode;
a co-sintering step of the different layers in a sintering tool at a ceramic sintering temperature capable of making said ceramic layer designed to form the electrolyte with a densification of more than 90%, gas tight.

10. Method of manufacturing a proton conducting electrochemical cell according to claim 1, claim 1 wherein said co-sintering step is done at a sintering temperature enabling densification of the electrolyte to more than 94%.
